(19) United States
(12) Patent Application Publication
(10) Pub. No.: US 2026/0132687 A1
(43) Pub. Date: May 14, 2026

(54) GRIPPING DEVICES AND SYSTEMS

(71) Applicant: BOART LONGYEAR MANUFACTURING AND DISTRIBUTION INC., Salt Lake City, UT (US)

(72) Inventors: Adrian Brubacher, North Bay (CA); Christopher Drenth, Callander (CA)

(21) Appl. No.: 19/118,552

(22) PCT Filed: Oct. 6, 2023
(86) PCT No.: PCT/US2023/076206

§ 371 Date: Apr. 4, 2025

Related U.S. Application Data
(60) Provisional application No. 63/413,822, filed on Oct. 6, 2022.

(51) Int. Cl. E21B 19/06; F16B 21/16

(52) U.S. Cl. CPC E21B 19/06; F16B 21/165

(57) ABSTRACT

A gripping apparatus includes an inner sleeve having an outer surface and an inner bore. The inner sleeve defines at least one radial opening that extends from the outer surface to the inner bore. The inner sleeve is at least partly received within the interior space of an outer sleeve. At least one rolling locking element is positioned within the at least one radial opening of the inner sleeve. The inner surface of the outer sleeve is shaped so that rotation of the outer sleeve relative to the inner sleeve drives the at least one rolling locking element radially inwardly into the inner bore of the inner sleeve, and axial movement of the outer sleeve relative to the inner sleeve in an axial direction opposite drives the at least one rolling locking element radially inwardly into the inner bore of the inner sleeve.

### CROSS-REFERENCE TO RELATED APPLICATION

This application claims priority to and the benefit of the filing date of U.S. Provisional Application No. 63/413,822, filed Oct. 6, 2022, the entirety of which is hereby incorporated by reference herein.

### FIELD

This application relates to tools for gripping tubular components such as drill string components and components for use with drill strings.

### BACKGROUND

Securely gripping tubular components can be beneficial in various applications, including in drilling and mining applications. For example, when decoupling a threadedly coupled pair of proximal and distal portions of an inner tube assembly, conventionally, two hand-wrenches are required to break the threaded joint.

In another application, multiple clam-shell style clamps or multiple vice-grip style clamps have been used to hold an inner tube relative to a rod string to prevent the inner tube from falling into or out of the drill string (e.g., when the drill string is extending upwardly).

Such devices are prone to slippage, failure, and can lead to injury.

### SUMMARY

Disclosed herein, in various aspects, is a gripping apparatus having a first end and a second end that is spaced from the first end along a central axis in a first axial direction. The gripping apparatus includes an inner sleeve having an outer surface and an inner bore. The inner sleeve defines at least one radial opening that extends from the outer surface to the inner bore. An outer sleeve has an inner surface that defines an interior space. The inner sleeve is at least partly received within the interior space of the outer sleeve. At least one rolling locking element is positioned within the at least one radial opening of the inner sleeve. The inner surface of the outer sleeve is shaped so that rotation of the outer sleeve relative to the inner sleeve drives the at least one rolling locking element radially inwardly into the inner bore of the inner sleeve, and axial movement of the outer sleeve relative to the inner sleeve in a second axial direction opposite the first axial direction drives the at least one rolling locking element radially inwardly into the inner bore of the inner sleeve.

In one aspect, a first system includes a first gripping apparatus and a second gripping apparatus. Each inner sleeve of the first and second gripping apparatuses has a respective first end portion. A coupling engages the first end portion of the inner sleeve of the first gripping apparatus and the first end portion of the inner sleeve of the second gripping apparatus so that the first ends of the first and second gripping apparatuses face each other.

A method of using the first system comprises sliding the first gripping apparatus over an outer surface of a drill string and receiving an inner tube assembly within the second gripping apparatus.

In one aspect, a second system includes first, second, and third gripping apparatuses. Each inner sleeve of the first and second gripping apparatuses has a first end portion and a second end portion. A coupling engages the first end portion of the first gripping apparatus and the second end portion the second gripping apparatus so that the first end of the first gripping apparatus faces the second end of the second gripping apparatus.

A method of using the second system comprises sliding the first gripping apparatus over an outer surface of a drill string, receiving an inner tube assembly within the second gripping apparatus, and sliding the third gripping apparatus over the inner tube assembly so that the second end of the third gripping apparatus faces the first end of the second gripping apparatus

Additional advantages of the disclosed apparatuses, systems, and methods will be set forth in part in the description which follows, and in part will be understood from the description, or may be learned by practice of the disclosed apparatuses, systems, and methods. The advantages of the disclosed apparatuses, systems, and methods will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a cross sectional view of a system comprising a plurality of gripping apparatuses as disclosed herein.

FIG. 2 is a cross sectional view of another system comprising a plurality of gripping apparatuses as disclosed herein.

FIG. 3 is a cross sectional view of the system of FIG. 1, taken in the plane 3-3 in FIG. 1.

FIG. 4 is an axial schematic view of a gripping apparatus received over a tubular member as disclosed herein.

FIG. 5 is a sectional view of the gripping apparatus of FIG. 4, taken in the plane 5-5 of FIG. 4.

FIG. 6 is a sectional view of the gripping apparatus of FIG. 4, taken in the plane 6-6 of FIG. 4.

FIG. 7 is a sectional view of the gripping apparatus of FIG. 4, taken in the cutting plane 7-7 of FIG. 4.

FIG. 8 is a sectional view of the gripping apparatus of FIG. 4, taken in the cutting plane 8-8 of FIG. 4.

FIG. 9 is a perspective view of the outer body of the gripping apparatus of FIG. 4.

FIG. 10 is a schematic view of an exemplary gripping apparatus having at least one first rolling locking element and at least one second rolling locking element that are axially spaced as further disclosed herein.

### DETAILED DESCRIPTION

The disclosed apparatuses, systems, and methods may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

As used in the specification and the appended claims, the singular forms “a,” “an” and “the” can include plural referents unless the context clearly dictates otherwise. Thus, for example, unless the context clearly dictates otherwise, disclosure of “a rolling locking element” can represent disclosure of embodiments in which only a single such rolling locking element is provided, as well as embodiments in which a plurality of such rolling locking elements are provided.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

As used herein, the term “proximal” refers to a direction toward a drill rig or drill operator (and away from a formation or borehole), while the term “distal” refers to a direction away from the drill rig or drill operator (and into a formation or borehole).

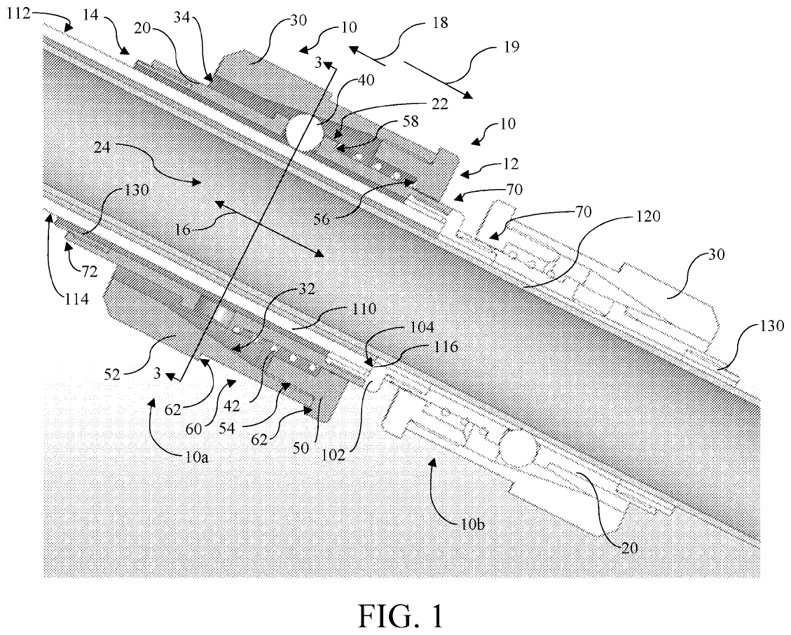

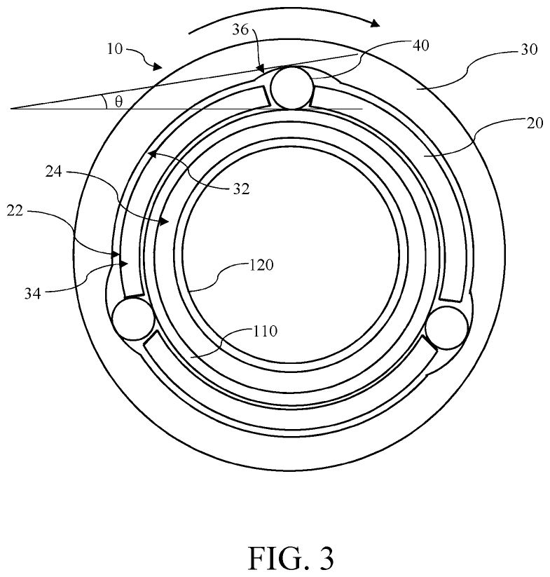

Disclosed herein, in various aspects, and with reference to FIGS. 1 and 3, is a gripping apparatus 10 having a first end 12 and a second end 14 that is spaced from the first end along a central axis 16 in a first axial direction 18. The gripping apparatus 10 can comprise an inner sleeve 20 having an outer surface 22 and an inner bore 24. The inner sleeve 20 can define at least one radial opening 26 that extends from the outer surface 22 to the inner bore 24. The gripping apparatus 10 can further comprise an outer sleeve having 30 an inner surface 32 that defines an interior space 34. The inner sleeve 20 can be at least partly received within the interior space 34 of the outer sleeve 30.

At least one rolling locking element 40 (referred to herein also as “locking elements”) can be positioned within the at least one radial opening 26 of the inner sleeve 20. The locking element(s) 40 can be spherical, cylindrical, conical, or any suitable shape. The locking element(s) 40 can comprise bearing grade hardened stainless steel rollers.

Optionally, the gripping apparatus 10 can have a single rolling locking element 40. In alternative aspects, the gripping apparatus 10 can comprise a plurality of rolling locking elements 40, such as, for example, 2, 3, 4, 5, 6, 7, 8, or more rolling locking elements 40.

The inner surface 32 of the outer sleeve 30 can be shaped so that rotation of the outer sleeve 30 relative to the inner sleeve 20 drives the at least one rolling locking element 40 radially inwardly into the inner bore 24 of the inner sleeve 20. Accordingly, when a tubular component is received within inner bore 24 of the inner sleeve 20 and in contact with the at least one rolling locking element 40, rotation of the outer sleeve 30 relative to the tubular component (and, thus the at least one rolling element 40) wedges the at least one rolling locking element 40 radially inwardly against the tubular component.

The inner surface 32 of the outer sleeve 30 can further be shaped so that axial movement of the outer sleeve 30 relative to the inner sleeve 20 in a second axial direction 19 opposite the first axial direction 18 drives the at least one rolling locking element radially inwardly into the inner bore 24 of the inner sleeve 20. Accordingly, when a tubular component is received within the inner bore 24 of the inner sleeve 20 and in contact with the at least one rolling locking element 40, axial movement of the outer sleeve 30 relative to the tubular component (and, thus the at least one rolling element 40) wedges the at least one rolling locking element 40 radially inwardly against the tubular component.

With a tubular component (e.g., a drill rod 110 or an inner tube assembly 120) received within the inner bore 24 of the inner sleeve 20, radially inward movement of the rolling locking elements 40 into the inner bore 24 of the inner sleeve 20 can bias the rolling locking elements 40 against the outer surface of the tubular component. Biasing of the rolling locking elements 40 against the outer surface of the tubular component can, in turn, drive the rolling locking elements 40 against the inner surface 32 of the outer sleeve 30, thereby generating a wedging effect that inhibits movement of the outer sleeve 30 relative to the tubular component.

In some aspects, the inner surface 32 of the outer sleeve 30 can define a taper in the first axial direction 18. Accordingly, in some aspects, along the central axis 16 of the gripping apparatus 10 in the first axial direction 18, a spacing between the inner surface 32 of the outer sleeve 30 and the central axis 16 can decrease. In this way, axial movement of the outer sleeve 30 relative to the inner sleeve 20 in a second axial direction 19 can drive the at least one rolling locking element radially inwardly into the inner bore 24 of the inner sleeve 20.

Referring to FIG. 3, the inner surface 32 of the outer sleeve 30 can define at least one channel 36. Each rolling locking element 40 can be received within a respective channel 36 of the at least one channel. In some aspects, each channel 36 can have an arcuate profile in cross sections in planes perpendicular to the central axis 16. In this way, rotation of the outer sleeve 30 relative to the inner sleeve 20 can drive the at least one rolling locking element 40 radially inwardly into the inner bore of the inner sleeve. In some optional aspects, the arcuate profile has a constant radius in each plane perpendicular to the central axis 16.

It is contemplated that an angle between the outer sleeve 30 and the outer surface of the tubular component can promote wedging of the rolling locking elements 40 to inhibit movement of the outer sleeve 30 relative to the tubular component, whereas an angle above said predetermined angle permits the rolling locking elements 40 to slip without wedging. Accordingly, the inner surface 34 of the outer sleeve 30 can taper so that, in planes including the central axis (e.g., the plane in which FIG. 1 is taken), the inner surface 34 of the outer sleeve 30 forms a first angle relative to the central axis that is less than or equal to the predetermined angle. Similarly, when rotating the outer sleeve relative to the inner sleeve, the outer sleeve can wedge the rolling locking elements 40 against the tubular component at a second angle that is less than the predetermined angle. In some aspects, the first and second angles can be the same. In other aspects, the first and second angles can be different.

Accordingly, in some aspects, upon sufficient rotation of the outer sleeve 30 relative to the inner sleeve 20 so that the at least one locking rolling element 40 is driven radially inwardly into the inner bore of the inner sleeve (and against the tubular member), in a plane perpendicular to the central axis 16, a line tangential to a portion of the inner surface of the outer sleeve contacting one rolling locking element 40 can form a second angle that is less than the predetermined angle with a line that is tangential to an inner surface of the inner sleeve. In this way, lines tangential to the outer sleeve 30 and the tubular component can, at points where the outer sleeve 30 and tubular component are contacting each rolling locking element 40, form an angle θ that is less than the predetermined angle in order to promote wedging and inhibit rotational movement between the outer sleeve 30 and the tubular component. The angle θ shown in FIG. 3 corresponds to wedging when the outer sleeve 30 is twisted relative to the tubular component in the direction indicated in FIG. 3. It is contemplated, however, that the gripping apparatus 10 can inhibit rotation of the outer sleeve 30 relative to the tubular component in either direction.

It is contemplated that the predetermined angle (that each of the first and second angles is less than or equal to) that promotes wedging of the rolling locking elements 40 to inhibit movement of the outer sleeve 30 relative to the tubular component can be a function of the material properties (hardness, roughness, etc.) of the inner surface of the outer sleeve 30 and the rolling locking element(s) 40, as well as the tubular component received within the inner sleeve 20. For example, all of the combined material properties can result in a contact pressure or stress in a contact patch area. An excessively steep taper can overcome frictional forces and drive the rolling locking element into sliding contact at one or both interfaces (i.e. inhibiting wedging), whereas a sufficiently shallow taper allows frictional forces to overcome rolling resistance and drive the rolling locking element in rotation despite increasing contact pressure through wedging. Accordingly, the predetermined angle can be a function of balancing between rolling resistance and sliding resistance. As an example, increased material hardness and stiffness reduces the contact patch area, and increases contact pressure and friction, to promote rolling and wedging action. Further, too shallow of a taper can lead to excessive travel of the outer sleeve, which can be undesirable in certain situations. In various aspects, the predetermined angle can be less than 15 degrees, or about 10 degrees, or less than 10 degrees, 9 degrees, or 8 degrees, or 7 degrees, or 6 degrees, or 5 degrees or less. It is contemplated that the first angle can be about or at least 5 degrees, about or at least 6 degrees, about or at least 7 degrees, about or at least 8 degrees, about or at least 9 degrees, or about or at least 10 degrees. It is contemplated that the second angle can be about or at least 5 degrees, about or at least 6 degrees, about or at least 7 degrees, about or at least 8 degrees, about or at least 9 degrees, or about or at least 10 degrees.

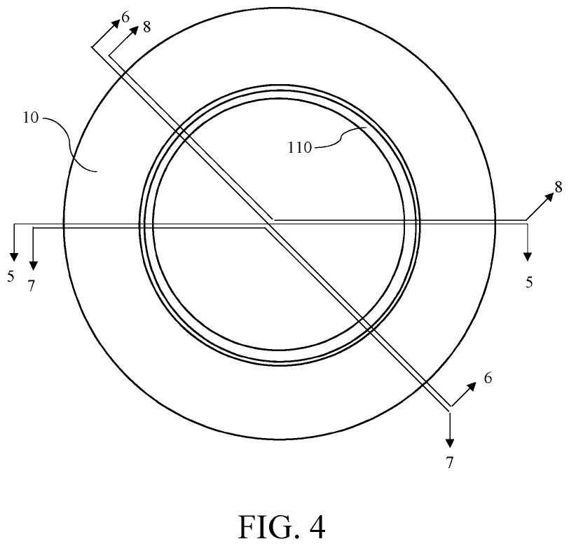

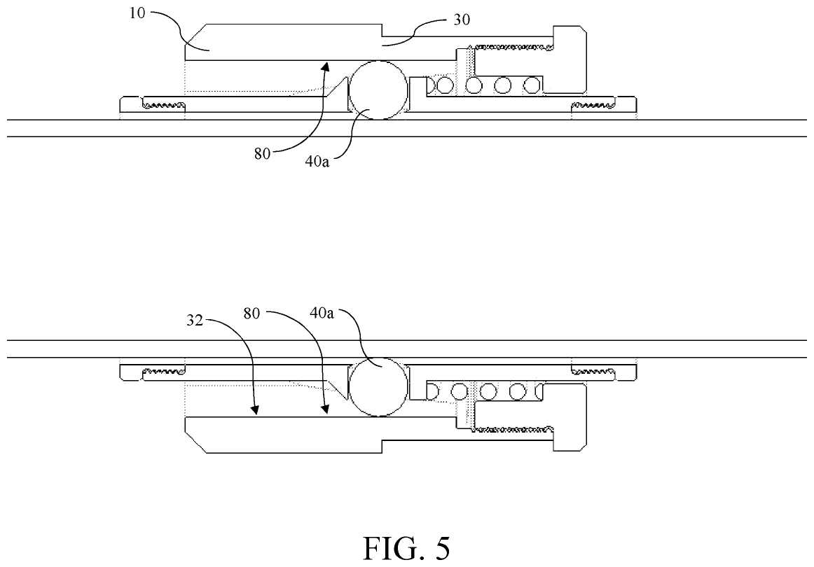

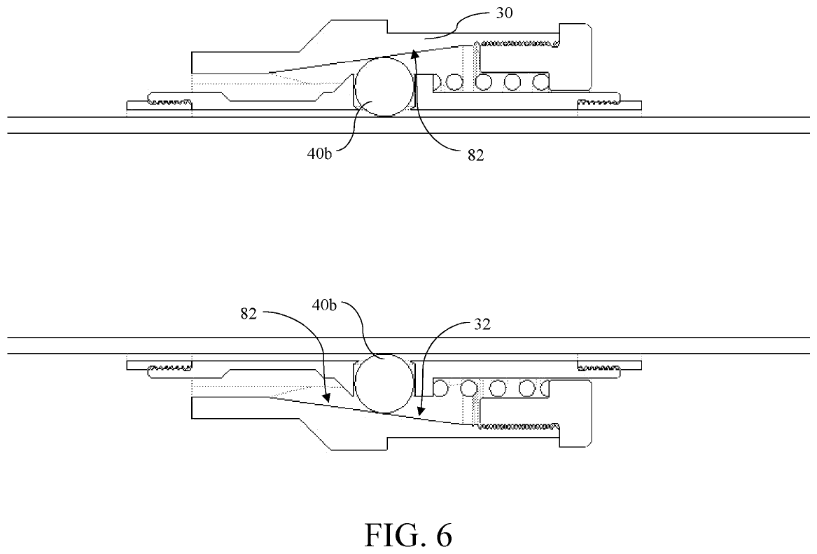

Optionally, the gripping apparatus 10 can comprise a plurality of rolling locking elements 40, and each rolling locking elements 40 can be configured to cooperate with the inner sleeve 20 and outer sleeve 30 to lock upon rotational movement of the inner sleeve 20 and outer sleeve 30 and upon axial moment of the inner sleeve relative to the outer sleeve. In other aspects, and with reference to FIGS. 4-9, the plurality of rolling locking elements 40 can comprise at least one first rolling locking element 40a (optionally a plurality of first rolling locking elements 40a) and at least one second locking rolling element 40b (optionally a plurality of second locking rolling elements 40b). The first locking rolling element(s) 40a can cooperate with the inner sleeve 20 and outer sleeve 30 to lock upon rotational movement of the inner sleeve 20, and the second locking element(s) 40b can cooperate with the inner sleeve 20 and outer sleeve 30 to inhibit axial movement. Accordingly, when a tubular component is received within inner bore 24 of the inner sleeve 20 and in contact with the at least one first rolling locking element 40a, rotation of the outer sleeve 30 relative to the tubular component (and, thus the at least one first rolling locking element 40a) wedges the first rolling locking element(s) 40a radially inwardly against the tubular component; and when a tubular component is received within the inner bore 24 of the inner sleeve 20 and in contact with the second rolling locking element(s) 40b, axial movement of the outer sleeve 30 relative to the tubular component (and, thus the second rolling locking element(s) 40b) wedges the second rolling locking element(s) 40b radially inwardly against the tubular component.

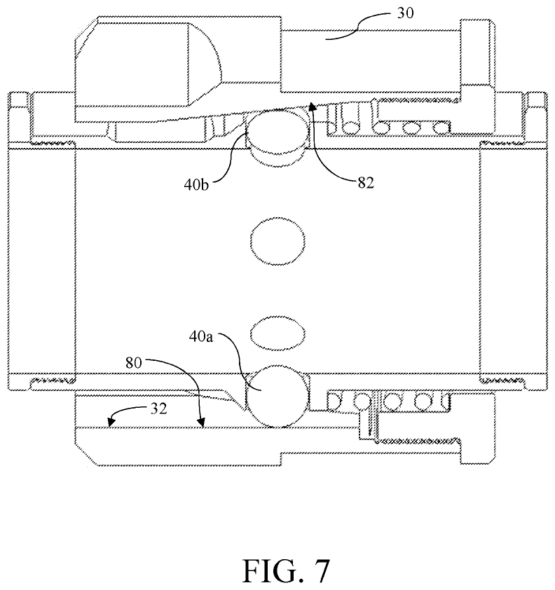

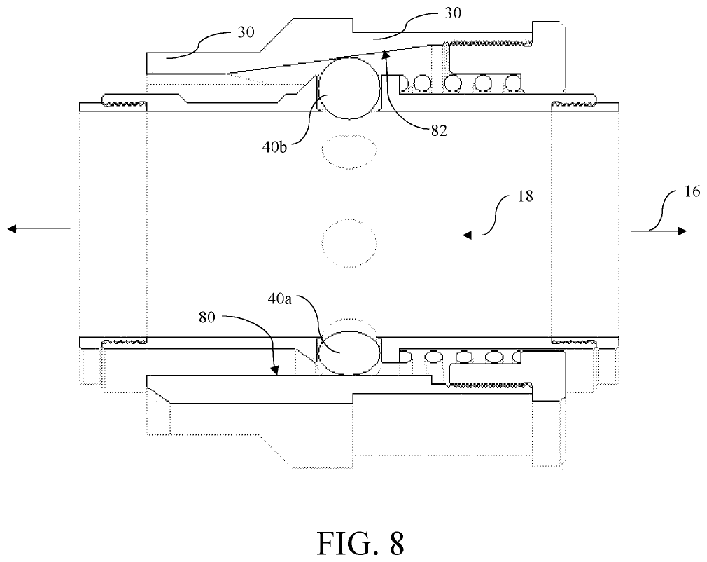

In some aspects, and with reference to FIGS. 7-8, the at least one first rolling locking element 40a and the at least one second rolling locking element 40b can be circumferentially spaced. For example, the at least one first rolling locking element 40a and the at least one second rolling locking element 40b can be arranged in an alternating fashion about the circumference of the inner sleeve 20. Optionally, in some aspects, the at least one first rolling locking element 40a can comprise a plurality of first rolling locking elements, and the at least one second rolling locking element 40b can comprise a plurality of first rolling locking elements, and the plurality of first rolling locking elements and the plurality of second rolling locking elements can be positioned in an alternating arrangement, with a second rolling locking element positioned circumferentially between two first rolling locking elements. Optionally, the plurality of first rolling locking elements and the plurality of second rolling locking elements can be positioned in an alternating arrangement at a common/single axial location.

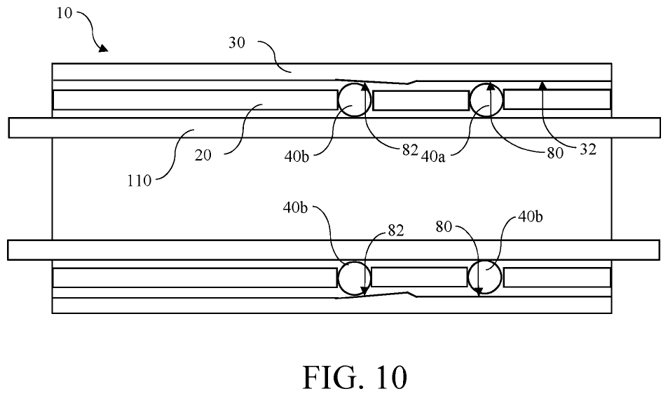

In some aspects, and with reference to FIG. 10, the at least one first rolling locking element 40a and the at least one second rolling locking element 40b can be axially spaced. For example, the at least one first rolling locking element 40a can comprise a plurality of first rolling locking elements 40a circumferentially spaced about the inner sleeve 20 in a first position along the central axis 16, and at least one second rolling locking element 40a can comprise a plurality of second rolling locking elements 40a circumferentially spaced about the inner sleeve 20 in a second position along the central axis 16.

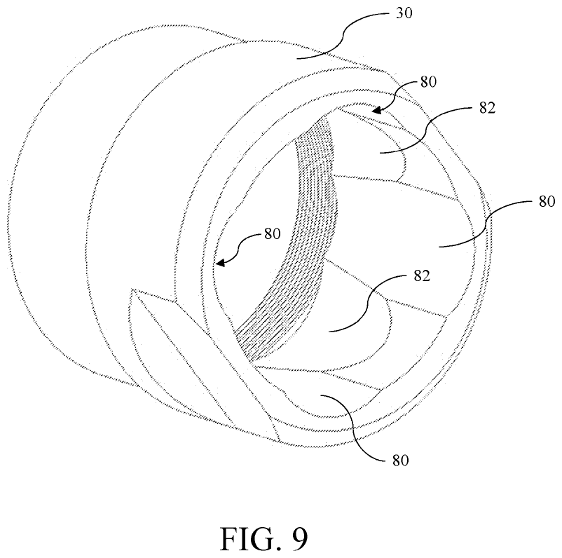

Referring to FIGS. 8 and 9, the outer sleeve 30 can define a respective first surface portion 80 of the inner surface of the outer sleeve that is configured to engage each first rolling locking element 40a. For example, the outer sleeve 30 can define a plurality of first surface portions 80. The outer sleeve 30 can further define a respective second surface portion 82 that is configured to engage each second rolling locking element 40b. The first surface portion(s) 80 can comprise an arcuate profile in cross sections in planes perpendicular to the central axis 16, as illustrated and described with reference to FIG. 3. For example, the first surface portion(s) 80 can engage the first rolling locking element(s) 40a at an angle that is less than the predetermined angle that permits the rolling locking elements 40a to slip without wedging. In this way, rotation of the outer sleeve 30 relative to the inner sleeve 20 can drive the at least one rolling locking element 40 radially inwardly into the inner bore of the inner sleeve. In some optional aspects, the first surfaces 80 can have a constant radius in each plane perpendicular to the central axis 16.

In some aspects, the second surface portions 82, in cross sections in planes perpendicular to the central axis 16, can have a different radius than the first surface portions 80. For example, the second surface portions 82 can have a smaller radius than the first surface portions 80 in cross sections in planes perpendicular to the central axis 16. Accordingly, the second surface portions 82 can engage the second rolling locking element(s) 40b at an angle that is greater than the predetermined angle that permits the second rolling locking elements 40b to slip without wedging. In this way, as the tubular component rotates axially about the central axis 16 relative to the gripping apparatus 10, the second rolling locking elements 40b can roll or slide rather than wedging.

In planes including the central axis 16, the first surface portion(s) 80 can have a substantially constant radius from the central axis 16. In planes including the central axis 16, the second surface portion(s) 82 can have a decreasing radius from the central axis 16 moving in the first direction 18.

In some aspects, the outer sleeve 30 can comprise a first portion 50 and a second portion 52 that are coupled together (e.g., via a threaded coupling 54).

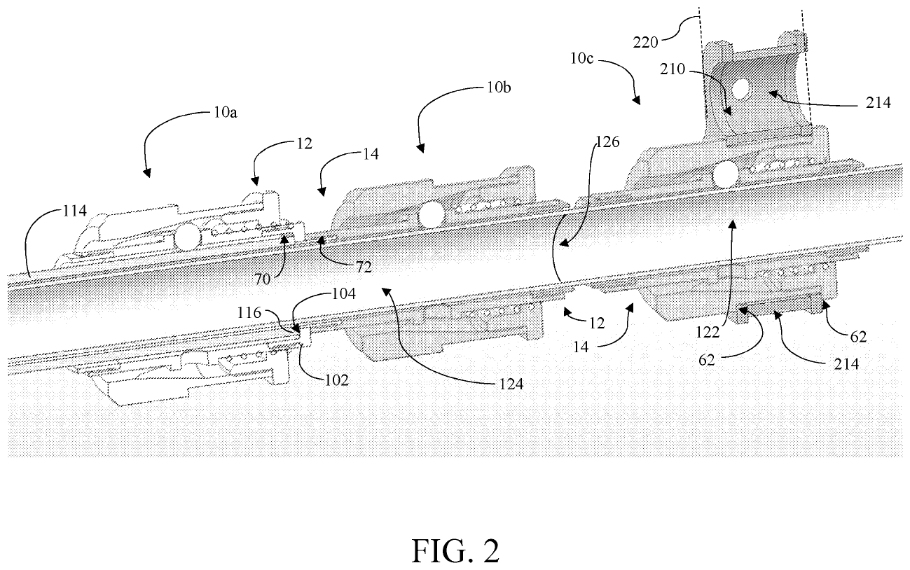

In some aspects, and with further reference to FIG. 2, the gripping apparatus 10 can be configured to adaptably couple to one or more attachments, such as a wrench handle or an adapter for coupling to a wireline cable, as further disclosed herein. For example, the gripping apparatus 10 can define an outer annular recess 60 between axially spaced circumferential radially extending lips 62. In some aspects, the first portion 50 can define a first lip 62a, and the second portion 52 can define a second lip 62b. Accordingly, the first and second portions can be decoupled in order to receive an attachment having an annular sleeve that is receivable over a portion of the outer surface of the outer sleeve defining the outer annular recess 60, and the first and second portions 50, 52 can be coupled together to retain the attachment between the first and second lips 62a,b. In some optional aspects, the outer annular recess 60 can comprise a feature (e.g., a spline) that cooperates with a corresponding feature (e.g., a spline) of the attachment in order to inhibit rotational movement of the attachment about the outer sleeve 30.

In some aspects, the gripping apparatus 10 can comprise a biasing element 42 (e.g., a coiled spring) that biases the inner sleeve 20 in the first axial direction 18 relative to the outer sleeve 30. In this way, the gripping apparatus 10 can be biased into a configuration in which the rolling locking elements 40 contact a tubular member received therein. The outer sleeve 30 can define a base lip 56, and the inner sleeve 20 can define a radially extending lip. The biasing element 42 can bias against the base lip 56 and the radially extending lip 58. It is contemplated that the biasing element 42 can maintain an axial position of the outer sleeve 30 relative to the inner sleeve 20 so that any (or substantially any) rotational movement of the outer sleeve 30 relative to the inner sleeve or any (or substantially any) axial movement of the outer sleeve relative to the inner sleeve in the second axial direction 19 causes wedging of the rolling locking elements 40. That is, the biasing element 42 can reduce play between the gripping apparatus 10 and the tubular component. Without a tubular component received within the inner sleeve 20, the biasing element 42 can drive the inner sleeve relative to the outer sleeve, rotationally until the rolling element(s) 40 are centered in the arcuate channels, and axially until the rolling element(s) reach radial inward seat/limits.

In some aspects, the gripping apparatuses 10 can be coupled together. For example, in some aspects, the inner sleeve 20 can have a first end portion 70 and an opposing second end portion 72. At least one of the first end portion 70 or the second end portion 72 can define at least one thread 74. Optionally, each of the first and second end portions 70, 72 of the inner sleeve 20 can define at least one thread 74. In some aspects, the at least one thread 74 can be female. In other aspects, the at least one thread 74 can be male.

### Exemplary System 1

Referring to FIG. 1, a system 100 can comprise a first gripping apparatus 10a and a second gripping apparatus 10b. A coupling 102 can engage (e.g., be threadedly secured to) the first end portion 70 of the inner sleeve 20 of the first gripping apparatus 10a and the first end portion 70 of the inner sleeve 20 of the second gripping apparatus 10 so that the first ends 12 of the first and second gripping apparatuses 10a,b face each other.

The inner bore 24 of the inner sleeve 20 of the first gripping apparatus 10 can have a first radial dimension (e.g., a diameter). The inner bore 24 of the inner sleeve 20 of the second gripping apparatus 10b can have a second radial dimension. In some optional aspects, the second radial dimension can be less than the first radial dimension. The radial dimension can correspond to the limit of the outer diameter (or other radial dimension) of a tubular component that can be received within the inner bore. Optionally, the coupling can define an inner radial lip 104.

The system 100 can advantageously be used for holding a tubular component (e.g., an inner tube assembly 120) that is deployable into a drill string in position relative to the drill string. For example, in upward drilling, where a distal end of a drill string 114 is vertically above a proximal end of the drill string, the inner tube assembly 120 can be inclined to fall from the drill string out the proximal end of the drill string. The system 100 can prevent the inner tube assembly 120 from falling out of the drill string 114.

For example, the first gripping apparatus 10 can be slid over an outer surface 112 of a drill string 114 (e.g., a proximal-most drill rod 110). In some optional aspects, the gripping apparatus 10 can be slid over the outer surface 112 of the drill string 114 until the radial inner lip contacts a proximal end 116 of the drill string 114. The inner tube assembly 120 can be received within the second gripping apparatus 10b. In this way, the inner tube assembly 120 can be held so that it cannot move in a proximal direction (indicated by arrow 19 in FIG. 1) relative to the drill string 114.

With the inner tube assembly 120 held by the second gripping apparatus 10b, proximal and distal portions of the inner tube assembly that are held together via a threaded connection can be separated. For example, optionally, a conventional wrench can be used to grip and rotate the proximal portion of the inner tube assembly with the distal portion held rotationally fixed by the second gripping apparatus 10b. In other optional aspects, a third gripping apparatus, as further disclosed herein with reference to FIG. 2, can be used to grip and rotate the proximal portion of the inner tube assembly with the distal portion held rotationally fixed by the second gripping apparatus 10b.

The outer sleeve 30 can be biased in the first direction 18 relative to the inner sleeve 20 to release the first gripping apparatus 10a from the drill string 114. For example, an operator can apply an external force to overcome the spring bias of the biasing element 42 to release the first gripping apparatus 10a.

### Exemplary System 2

Referring to FIG. 2, a system 200 can be used for separating threaded coupling 126 between proximal and distal portions 122, 124 of an inner tube assembly 120. The system 200 can comprise first, second, and third gripping apparatuses 10a,b,c. A coupling 102 can engage the first end portion 70 of the first gripping apparatus and the second end portion the second gripping apparatus so that the first end 12 of the first gripping apparatus 10a faces the second end 14 of the second gripping apparatus 10b. Accordingly, like the system 100, the first gripping apparatus 10 can be slid over an outer surface 112 of a drill string 114 (e.g., a proximal-most drill rod 110), optionally, until the radial inner lip contacts a proximal end 116 of the drill string 114. Contrasting to the system 100, the second gripping apparatus 10b can permit movement of the inner tube assembly 120 in a proximal direction relative to the drill string 114 but can inhibit distal movement of the inner tube assembly relative to the drill string.

The third gripping apparatus 10c can be used to grip the proximal end portion 122 of the inner tube assembly 120 while the second gripping apparatus 10b holds the distal end portion 124. Accordingly, the threaded coupling 126 between proximal and distal portions 122, 124 of an inner tube assembly 120 can be axially positioned between the rolling locking elements 40 of the first gripping apparatus 10a and the second gripping apparatus 10b. The third gripping apparatus 10c can be used to apply a torque to the proximal end portion 122 of the inner tube assembly 120 to separate the proximal and distal end portions 122, 124.

In some aspects, a wrench handle 220 (shown schematically in broken lines) can couple to the third gripping apparatus 10c. For example, optionally, the wrench handle can comprise a sleeve that is receivable into the outer annular recess 60 of the third gripping apparatus 10c. The wrench handle can extend radially outwardly from the central axis 16 of the third gripping apparatus 10c. In some aspects, the wrench handle can couple to the third gripping apparatus 10c without weldment. In some aspects, the wrench handle 220 can couple to the third gripping apparatus 10c without weldment. For example, the wrench handle 220 can be integrally formed with a sleeve 214 that circumferentially surrounds the third gripping apparatus 10c. The sleeve 214 can be held axially between opposed lips 62 of the third gripping apparatus 10 c, within the annulus 60. The third gripping apparatus 10 c can comprise at least feature (e.g., one or more splines) that cooperates with corresponding feature (one or more splines) of sleeve 212 to inhibit rotation of the wrench handle relative to the third gripping apparatus 10c. In various aspects, the outer annular recess 60 of the third gripping apparatus 10c can comprise feature (e.g., a spline, a single raised rib, or a spigot feature) that mates with a corresponding feature of the sleeve 214 (e.g., a spline, a complementary hole, or a recess). In some optional aspects, the wrench handle 220 can be configured to grip the outer surface of the third gripping apparatus 10c via friction that can be generated as a function of application of leverage against the third gripping apparatus.

In some aspects, the third gripping apparatus 10c can comprise an adapter 210 for coupling to a wireline cable. For example, a wireline tool (not shown) that is coupled to a wireline cable can comprise radially extending locking members that extend outwardly to couple to a receptacle having a cylindrical inner surface. Accordingly, in some optional aspects, the adapter 210 can define a receptacle 212 having cylindrical inner surface that is configured to receive the wireline tool for coupling to said tool. In other aspects, the adapter 210 can comprise a spear point that is configured to receive and couple to a traditional spear point wireline coupler. In this way, the third gripping apparatus 10c can be used to lift the proximal end portion of the inner tube assembly. In some aspects, the adapter 210 can couple to the third gripping apparatus 10c without weldment. For example, the adapter 210 can be integrally formed with a sleeve 214 that circumferentially surrounds the third gripping apparatus 10c. The sleeve 214 can be held axially between opposed lips 62 of the third gripping apparatus 10c.

A method of using the system 200 can comprise sliding the first gripping apparatus 10a over an outer surface 116 of a drill string 116. An inner tube assembly 120 can be received within the second gripping apparatus 10b. For example, the inner tube assembly 120 can be received within the second gripping apparatus 10b so that a threaded coupling 126 between proximal and distal portions 122, 124 of an inner tube assembly 120 can be axially positioned between the rolling locking elements 40 of the first gripping apparatus 10a and the second gripping apparatus 10b. The third gripping apparatus 10c can be slid over the inner tube assembly 120 so that the second end 14 of the third gripping apparatus 10c faces the first end 12 of the second gripping apparatus 10b.

A torque can be applied to the third gripping apparatus 10c to separate the threaded coupling 126 of the inner tube assembly 120.

Protective inserts 130 can be threadedly coupled to the thread(s) 74 of the inner sleeve 20 that are not otherwise used for coupling to protect the threads.

### Exemplary Advantages of Disclosed Embodiments

Embodiments disclosed herein can improve handling of devices such as those in drilling and mining environments. However, it is contemplated that the disclosed gripping devices can be used in varieties of applications where gripping or holding tubular components is desirable.

Traditional clamps and wrenches (e.g., for separating threaded components) use hardened tool-steel or tungsten-carbide gripper teeth which damage the clamped tube and allow for slippage and injury. Alternative rubber clamps are subject to wear or loss of grip due to lubrication or interface issues. The disclosed apparatuses and systems can provide improved grip over traditional wrenches without risking damage to the drill string or drilling/mining components.

Traditional welding of alloy-steel spearpoints for creates brittle connections subject to fatigue and sudden catastrophic failure. The disclosed apparatuses and systems can permit coupling to a wireline without risking failure of a weldment coupling.

The disclosed gripping apparatuses provides rotation-holding capability to eliminate a hand-wrench.

The disclosed gripping apparatuses can be coupled in different orientations, for example, to allow for holding inclined tubes within an inclined drill string.

The disclosed gripping apparatuses can permit gripping of different sizes of tubular components.

The disclosed gripping apparatuses can be configured to adaptably couple to different attachments such as a wrench handle or an adapter for coupling to a wireline.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

### Aspect 1

A gripping apparatus having a first end and a second end that is spaced from the first end along a central axis in a first axial direction, the gripping apparatus comprising:
an inner sleeve having an outer surface and an inner bore, wherein the inner sleeve defines at least one radial opening that extends from the outer surface to the inner bore;
an outer sleeve having an inner surface that defines an interior space, wherein the inner sleeve is at least partly received within the interior space of the outer sleeve; and
at least one rolling locking element positioned within the at least one radial opening of the inner sleeve,
wherein the inner surface of the outer sleeve is shaped so that:
   rotation of the outer sleeve relative to a tubular component received within inner bore of the inner sleeve and in contact with the at least one rolling locking element drives the at least one rolling locking element radially inwardly into the inner bore of the inner sleeve.

### Aspect 2

The gripping apparatus of aspect 1, wherein the at least one rolling locking element comprises a plurality of rolling locking elements.

### Aspect 3

The gripping apparatus of aspect 1 or aspect 2, wherein the inner surface of the outer sleeve is further shaped so that axial movement of the outer sleeve relative to the inner sleeve in a second axial direction opposite the first axial direction drives the at least one rolling locking element radially inwardly into the inner bore of the inner sleeve.

### Aspect 4

The gripping apparatus of aspect 3, wherein the inner surface of the outer sleeve defines a taper in the first axial direction.

### Aspect 5

The gripping apparatus of any one of the preceding aspects, wherein the inner surface of the outer sleeve defines at least one channel, wherein each rolling locking element of the at least one rolling locking element is received within a respective channel of the at least one channel, and wherein each channel of the at least one channel has an arcuate profile in cross sections in planes perpendicular to the central axis.

### Aspect 6

The gripping apparatus of aspect 5, wherein the arcuate profile has a constant radius.

### Aspect 7

The gripping apparatus of any one of the preceding aspects, wherein, upon sufficient rotation of the outer sleeve relative to the inner sleeve so that the at least one locking rolling element is driven radially inwardly into the inner bore of the inner sleeve, a line tangential to a portion of the inner surface of the outer sleeve contacting one rolling locking element of the at least one rolling locking element forms an angle that is less than 10 degrees with a line that is tangential to the outer surface of the inner sleeve.

### Aspect 8

The gripping apparatus of claim 1, wherein the at least one rolling locking element comprises a plurality of rolling locking elements, wherein the plurality of rolling locking elements comprise at least one first rolling locking element, and at least one second rolling locking element, wherein the inner surface of the outer sleeve comprises a first inner surface portion that is configured to engage the at least one first rolling locking element so that rotation of the outer sleeve relative to a tubular component received within inner bore of the inner sleeve and in contact with the at least one rolling locking element drives the at least one rolling locking element radially inwardly into the inner bore of the inner sleeve, and wherein inner surface of the outer sleeve comprises a second inner surface portion that is further shaped to engage the at least one second rolling locking element so that axial movement of the outer sleeve relative to the inner sleeve in a second axial direction opposite the first axial direction drives the at least one rolling locking element radially inwardly into the inner bore of the inner sleeve.

### Aspect 9

The gripping apparatus of any one of the preceding aspects, wherein the inner sleeve has a first end portion and an opposing second end portion, wherein at least one of the first end portion or the second end portion defines at least one thread.

### Aspect 10

The gripping apparatus of aspect 8, wherein each of the first and second end portions of the inner sleeve defines at least one thread.

### Aspect 11

The apparatus of any one of the preceding aspects, further comprising a biasing element that biases the inner sleeve in the first axial direction relative to the outer sleeve.

### Aspect 12

The apparatus of any one of the preceding aspects, wherein the inner surface of the outer sleeve is shaped so that rotation of the outer sleeve relative to a tubular component received within inner bore of the inner sleeve and in contact with the at least one rolling locking element drives the at least one rolling locking element radially inwardly against the tubular component.

### Aspect 13

A system comprising:
a first gripping apparatus and a second gripping apparatus according to any one of the preceding aspects, wherein each inner sleeve of the first and second gripping apparatuses has a respective first end portion; and
a coupling that engages the first end portion of the inner sleeve of the first gripping apparatus and the first end portion of the inner sleeve of the second gripping apparatus so that the first ends of the first and second gripping apparatuses face each other.

### Aspect 14

The system of aspect 13, wherein the inner bore of the inner sleeve of the first gripping apparatus has a first radial dimension, wherein the inner bore of the inner sleeve of the second gripping apparatus has a second radial dimension that is less than the first radial dimension.

### Aspect 15

The system of aspect 13 or aspect 14, wherein the coupling defines a radial lip.

### Aspect 16

A method of using the system of any one of aspects 13-15, comprising:
sliding the first gripping apparatus over an outer surface of a drill string; and
receiving an inner tube assembly within the second gripping apparatus.

### Aspect 17

A System Comprising:
first, second, and third gripping apparatuses according to any one of aspects 1-12, wherein each inner sleeve of the first and second gripping apparatuses has a first end portion and a second end portion;
a coupling that engages the first end portion of the first gripping apparatus and the second end portion the second gripping apparatus so that the first end of the first gripping apparatus faces the second end of the second gripping apparatus.

### Aspect 18

The system of aspect 17, wherein the third gripping apparatus comprises a wrench handle.

### Aspect 19

The system of aspect 17, wherein the third gripping apparatus comprises an adapter for coupling to a wireline cable.

### Aspect 20

A method of using the system as in any one of aspects 17-19, the method comprising:
sliding the first gripping apparatus over an outer surface of a drill string;
receiving an inner tube assembly within the second gripping apparatus; and
sliding the third gripping apparatus over the inner tube assembly so that the second end of the third gripping apparatus faces the first end of the second gripping apparatus.

### Aspect 21

The method of aspect 20, further comprising applying a torque to the third gripping apparatus to separate a threaded joint of the inner tube assembly.

Those skilled in the art will recognize, or be able to ascertain using no more than routine experimentation, many equivalents to the specific embodiments of the method and compositions described herein. Such equivalents are intended to be encompassed by the following claims.

What is claimed is:

1. A gripping apparatus having a first end and a second end that is spaced from the first end along a central axis in a first axial direction, the gripping apparatus comprising:
an inner sleeve having an outer surface and an inner bore, wherein the inner sleeve defines at least one radial opening that extends from the outer surface to the inner bore;
an outer sleeve having an inner surface that defines an interior space, wherein the inner sleeve is at least partly received within the interior space of the outer sleeve; and
at least one rolling locking element positioned within the at least one radial opening of the inner sleeve,
wherein the inner surface of the outer sleeve is shaped so that:
rotation of the outer sleeve relative to a tubular component received within inner bore of the inner sleeve and in contact with the at least one rolling locking element drives the at least one rolling locking element radially inwardly into the inner bore of the inner sleeve.

2. The gripping apparatus of claim 1, wherein the at least one rolling locking element comprises a plurality of rolling locking elements.

3. The gripping apparatus of claim 1, wherein the inner surface of the outer sleeve is further shaped so that axial movement of the outer sleeve relative to the inner sleeve in a second axial direction opposite the first axial direction drives the at least one rolling locking element radially inwardly into the inner bore of the inner sleeve.

4. The gripping apparatus of claim 3, wherein the inner surface of the outer sleeve defines a taper in the first axial direction.

5. The gripping apparatus of claim 1, wherein the inner surface of the outer sleeve defines at least one channel, wherein each rolling locking element of the at least one rolling locking element is received within a respective channel of the at least one channel, and wherein each channel of the at least one channel has an arcuate profile in cross sections in planes perpendicular to the central axis.

6. The gripping apparatus of claim 5, wherein the arcuate profile has a constant radius.

7. The gripping apparatus of claim 1, wherein, upon sufficient rotation of the outer sleeve relative to the inner sleeve so that the at least one locking rolling element is driven radially inwardly into the inner bore of the inner sleeve, a line tangential to a portion of the inner surface of the outer sleeve contacting one rolling locking element of the at least one rolling locking element forms an angle that is less than 10 degrees with a line that is tangential to the outer surface of the inner sleeve.

8. The gripping apparatus of claim 1, wherein the at least one rolling locking element comprises a plurality of rolling locking elements, wherein the plurality of rolling locking elements comprise at least one first rolling locking element, and at least one second rolling locking element, wherein the inner surface of the outer sleeve comprises a first inner surface portion that is configured to engage the at least one first rolling locking element so that rotation of the outer sleeve relative to a tubular component received within inner bore of the inner sleeve and in contact with the at least one rolling locking element drives the at least one rolling locking element radially inwardly into the inner bore of the inner sleeve, and wherein inner surface of the outer sleeve comprises a second inner surface portion that is further shaped to engage the at least one second rolling locking element so that axial movement of the outer sleeve relative to the inner sleeve in a second axial direction opposite the first axial direction drives the at least one rolling locking element radially inwardly into the inner bore of the inner sleeve.

9. The gripping apparatus of claim 1, wherein the inner sleeve has a first end portion and an opposing second end portion, wherein at least one of the first end portion or the second end portion defines at least one thread.

10. The gripping apparatus of claim 9, wherein each of the first and second end portions of the inner sleeve defines at least one thread.

11. The apparatus of claim 1, further comprising a biasing element that biases the inner sleeve in the first axial direction relative to the outer sleeve.

12. The apparatus of claim 1, wherein the inner surface of the outer sleeve is shaped so that rotation of the outer sleeve relative to a tubular component received within inner bore of the inner sleeve and in contact with the at least one rolling locking element drives the at least one rolling locking element radially inwardly against the tubular component.

13. A system comprising:
a first gripping apparatus and a second gripping apparatus according to claim 1, wherein each inner sleeve of the first and second gripping apparatuses has a respective first end portion; and
a coupling that engages the first end portion of the inner sleeve of the first gripping apparatus and the first end portion of the inner sleeve of the second gripping apparatus so that the first ends of the first and second gripping apparatuses face each other.

14. The system of claim 13, wherein the inner bore of the inner sleeve of the first gripping apparatus has a first radial dimension, wherein the inner bore of the inner sleeve of the second gripping apparatus has a second radial dimension that is less than the first radial dimension.

15. The system of claim 13, wherein the coupling defines a radial lip.

16. A method of using the system of claim 13, the method comprising:
sliding the first gripping apparatus over an outer surface of a drill string; and
receiving an inner tube assembly within the second gripping apparatus.

17. A system comprising:
first, second, and third gripping apparatuses according to claim 1, wherein each inner sleeve of the first and second gripping apparatuses has a first end portion and a second end portion; and
a coupling that engages the first end portion of the first gripping apparatus and the second end portion the second gripping apparatus so that the first end of the first gripping apparatus faces the second end of the second gripping apparatus.

18. The system of claim 17, wherein the third gripping apparatus comprises a wrench handle.

19. The system of claim 17, wherein the third gripping apparatus comprises an adapter for coupling to a wireline cable.

20. A method of using the system as in claim 17, the method comprising:
sliding the first gripping apparatus over an outer surface of a drill string;
receiving an inner tube assembly within the second gripping apparatus; and
sliding the third gripping apparatus over the inner tube assembly so that the second end of the third gripping apparatus faces the first end of the second gripping apparatus.

21. The method of claim 20, further comprising applying a torque to the third gripping apparatus to separate a threaded joint of the inner tube assembly.
